(19) United States
(12) Patent Application Publication
(10) Pub. No.: US 2026/0187548 A1
(43) Pub. Date: Jul. 2, 2026

(54) SYSTEM AND METHOD FOR GENERATING TRANSPORT CHAIN SERVICES

(71) Applicant: Uber Technologies, Inc., San Francisco, CA (US)

(72) Inventors: Alex Argutin, San Francisco, CA (US); Huy Nguyen, San Francisco, CA (US); David Lin, San Francisco, CA (US); Aaron Chazhoor, San Francisco, CA (US); Yash Tibrewala, San Francisco, CA (US); Jiamin Shi, San Francisco, CA (US); Naga Datta Madhu Kiran Thontepu, San Francisco, CA (US); Aditya Kumar, San Francisco, CA (US)

(21) Appl. No.: 19/336,265

(22) Filed: Sep. 22, 2025

Related U.S. Application Data
(60) Provisional application No. 63/740,858, filed on Dec. 31, 2024.

(51) Int. Cl. G06Q 10/02; G06Q 10/0631; G06Q 50/47

(52) U.S. Cl. CPC G06Q 10/025; G06Q 10/06311; G06Q 50/47

(57) ABSTRACT

A network system determines a group of transport chains to transport a number of individuals to and from a common site, where each transport chain provides transport for multiple job orders. The group of transport chains can be determined or otherwise configured to optimize one or more group-level metrics. The network system transmits data to a computing device associated with each user that is to be transported by transport chain, to provide the user information about the transport chain.

### RELATED APPLICATION(S)

This application claims benefit of priority to U.S. Provisional Patent Application No. 63/740,858, filed Dec. 31, 2024; the aforementioned priority application being hereby incorporated by reference in its entirety.

### TECHNICAL FIELD

Examples relate to a system and method for generating a transport chain service.

### BACKGROUND

On-demand transport systems exist to arrange various types of transport for individual requesters. These systems can also arrange or facilitate travel with high-capacity vehicles. Typically, individual users request transport using their mobile device, either for the present time or for a scheduled one. The on-demand transport system then implements processes to select service providers and to communicate the transport requests such that they can be fulfilled. While on-demand systems do provide the ability for multiple requesters at one time, these types of transport services are typically arranged ad-hoc and for individual requesters.

With increased congestion in cities, there is greater interest by enterprises to arrange group or mass transport for its personnel. By promoting group transport for its personnel, an enterprise can contribute to mitigating congestion, while at the same time providing its personnel with a benefit. To date, however, the options for such types of group transport have lacked in convenience or efficiency. Options for public transit, for example, often require personnel to transport themselves to a bus or train station, sometimes in unsafe conditions.

Other solutions that have been put forth include the use of high-capacity vehicles, such as buses. High-capacity vehicles can, in theory, be effective for group transport, provided that the vehicles can efficiently route to stops where passengers board or disembark. Some solutions provide for high-capacity vehicles to travel on corridors, where corridors define routes with some permissible deviation and flexibility in stopping locations and times. However, implementing such vehicles in corridors, rather than “door-to-door” transport, requires passengers to transport themselves to the stopping locations of the closest corridor. This can raise issues of safety and inconvenience for the personnel.

### BRIEF DESCRIPTION OF THE DRAWINGS

FIG. 1 illustrates an example network system for generating groups of transport chains, according to one or more embodiments.

FIG. 2 illustrates an example method for a network system to implement a group of transport chains, according to one or more embodiments.

FIG. 3 illustrates an example method for enabling a network system to optimize a group of transport chains, according to one or more embodiments.

FIG. 4 is a block diagram that illustrates a network system for use with one or more embodiments.

### DETAILED DESCRIPTION

According to examples, a network system implements sequenced, multi-passenger transport for a “door-to-door” type transport, to collectively transport a relatively large group of persons (e.g., 10 to 1000 persons) in accordance with a set schedule having a common boundary time (e.g., arrival time to an enterprise location or departure time from an enterprise location). Further, an example network system can optimize the group transport for one or more group-level objectives. For example, an example network system can be implemented to minimize inconvenience to passengers, while reducing the number of vehicles that are deployed to transport a given group.

An example network system transports a group of passengers utilizing a plurality of transport chains, where each transport chain is used to transport multiple users to or from a common location (e.g., enterprise site) at one or more specified or scheduled times. In examples, each transport chain is assigned to multiple users (e.g., passengers) who are to be transported to or from respective geographic endpoints (e.g., their home locations, or locations near their homes). In examples, a group transport can utilize transport chains which transport multiple passengers at once, and in some cases, singular or single-stop transports in combination with the transport chains, to provide “door-to-door” transport for each person of the group, to or from a common location (e.g., enterprise location) and in accordance with a schedule that includes a common boundary time. As described with examples, the transport of the group of persons, which includes a plurality of transport chains, and in some cases, singular or single-stop transport, are optimized for one or more group-level objectives.

As described with examples, a transport chain can be a singular or multi-passenger transport service provided by a vehicle, where the service extends between a common site for all requesters (or passengers), and geographic endpoints associated with each requester. A group of transport chains can correspond to transport chains that share a common endpoint and/or a common boundary time, where the boundary time identifies one of an initiation time or a termination time for the transport chain. A group of transport chains can also be associated with a common enterprise account. In some cases, an enterprise account can be associated with multiple locations, and multiple groups of transport chains can be determined for the account, such as particular shift times which may also be shared across the multiple locations of the enterprise.

The network system generates transport chains for time intervals that precede or follow a boundary time, where the boundary time identifies one of an initiation time or a termination time for the transport chain. A transport chain can include an arrival chain, where users of the transport chain are picked up at their individual respective geographic endpoints and transported to a common site. For an arrival chain, the boundary time can correspond to an arrival time (or estimated arrival time), representing a chain termination time for the transport chain, when a vehicle carrying the users of the transport chain arrives at the common site. A transport chain can also include a departure chain, where users of the transport chain are picked up at the common site and transported to their individual respective geographic endpoint (e.g., their home, or a location near their home). For a departure chain, the boundary time can correspond to a departure time, representing a chain initiation time, when a vehicle carrying the users of the transport chain departs the common site to transport the users to their respective geographic endpoints.

The network system generates transport chains for predetermined boundary times and common sites. A common site can be associated with, for example, at least one arrival time when a number of persons are to arrive at the site, and/or at least one departure time when a number of persons are to depart the site. By way of example, a common site can correspond to an enterprise site for personnel of an enterprise. An enterprise can manage operations at a site by defining shifts for its personnel, with each shift having a start time and an end time. In such case, a network system can generate (i) a group of arrival chains to transport enterprise personnel from their respective trip endpoints (e.g., their homes, or near their homes) to the common site before a shift start time, and (ii) a group of departure chains to transport the enterprise personnel from the common site to their respective trip endpoints.

In some examples, in generating a group of transport chains, the network system can optimize the group based on a set of objectives for the group. The objective(s) can include, for example, (i) minimizing a number of vehicles (or transport chains) used to complete the group of transport chains, (ii) minimizing an aggregation of chain completion time, and/or (iii) minimizing a chain travel distance for the group of transport chains. As an addition or variation, the objective(s) can include minimizing the total duration of transport for every requester receiving transport through the transport chain.

As another addition or variation, another objective for optimizing the group of transport chains can include minimizing inconvenience to the users that are being transported. An inconvenience metric can be based on a comparison of (i) the time and/or distance of travel for the individual user to be transported by transport chain, and (ii) another form of transport, such as one where the user is travel directly between the respective endpoints in a vehicle. An inconvenience metric can also be determined for individual passengers of a vehicle, based on a duration or distance of travel associated with route deviations a transport vehicle makes to pickup or drop-off other passengers that may be in the vehicle.

Still further, in additional examples, the objective(s) can include minimizing an occurrence of a restrictive occupancy condition. A restrictive occupancy condition is a condition that, when present, precludes a user from being an occupant of a transport vehicle. A user that is subject to a restrictive occupancy condition can be associated with a categorical designation, also referred to as a restrictive parameter. According to examples, transport chain is a transport service that concurrently fulfills multiple transport job orders at one time, where the transport job orders share a common endpoint (e.g., a common trip termination point or start point). A transport chain can include multiple segments or legs, where each segment or leg coincides with one of the multiple transport job orders that are being fulfilled through implementation of the transport chain.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Still further, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### Network System

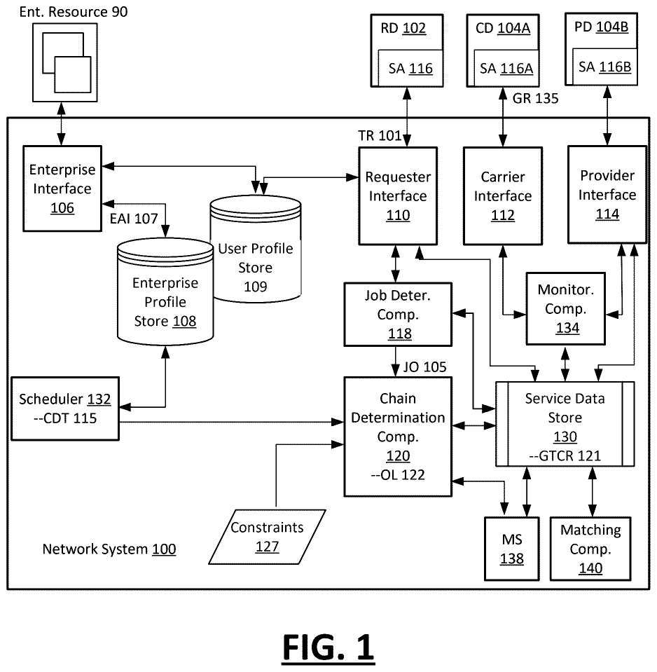

FIG. 1 illustrates an example network system for generating groups of transport chains, according to one or more embodiments. In examples as described, a network system 100 implements a group of transport chains for transporting a number of users to or from a common site at a designated time. The network system 100 enables a network platform in which transport chains can be generated and implemented. As described in greater detail, transport chains are an example of a multi-rider transport service. The network system 100 can provide multiple types of transport services, in addition to transport chains, such as, for example, singular transport (e.g., rider requests a transport service just for themselves), pooled transport (e.g., driver picks up additional riders who separately request the transport service, typically with different pickup locations and/or destination locations), bus transport (e.g., driver transports multiple riders in large-capacity vehicle, sometimes while following a pre-determined route), or delivery transport (e.g., service provider picks up and delivers an item).

Depending on implementation, the users of the network system 100 can include requesters (also referred to as “riders” or “passengers”), vehicle operators (also referred to as “service providers”, or “drivers”), carriers (e.g., fleet operators), account holders (e.g., enterprise account holders), and designated passengers or personnel. A service provider can utilize network system 100 to receive and fulfill transport job orders, through operation of a vehicle. A carrier can include a fleet operator that makes vehicles (including autonomous vehicles) and/or service providers available to the network system 100. An account holder can include an enterprise, operating a common site. In such examples, the requesters can include personnel of an enterprise who receive transport to and from a site associated with an enterprise, such as in connection with a shift schedule where personnel of the enterprise work on site. While numerous examples are described in context of an enterprise where requesters work (e.g., on a shift schedule), in other examples, transport chains can be generated for requesters who have a common interest or need to arrive at, or depart from, a common site at predetermined times. For example, transport chains can be used by a group of students who share a common schedule or need to be at school at the same time. Transport chains can also be used by participants of a social organization, in connection with meetings held by the social organization. As described with examples, transport chains provide an efficient mode of transport when a relatively large number of persons are to travel to and/or from a common site at set times. A group of transport chains can also be generated for personnel of multiple enterprises which are co-located. For example, multiple enterprises that are co-located can combine to implement a transport chain network for transporting personnel of each of the enterprises. Thus, in some examples, the group of transport chains can be shared amongst multiple enterprise accounts.

With reference to FIG. 1, an example network system 100 includes processes represented by an enterprise interface 106, a requester interface 110, a job determination component 118, a transport chain determination component 120, a service data store 130, and at least one of a carrier interface 112 or provider interface 114. The network system 100 is described in context of determining and implementing transport chains as one of multiple types of transport related services. In an example of FIG. 1, the network system 100 can also implement on-demand transport services (e.g., on-demand singular or pooled transport).

### Enterprise Interface

Processes represented by the enterprise interface 106 communicate with an enterprise resource 90 to receive enterprise account information 107, which can be stored in an enterprise account data store 108. The enterprise account information 107 can identify potential service requesters that are associated with the enterprise (e.g., enterprise personnel). Each potential service requester can be identified by, for example, a user account identifier, mobile number or other identifier associated with the user or the user device. In additional examples, the enterprise account information 107 can include scheduling information for the personnel of the enterprise, such as the start and end times of predetermined shifts.

The enterprise account information 107 can also include a shift schedule. A shift schedule can identify shifts during individual days of a week where personnel of an enterprise are at a common site to work. In some examples, a shift can be characterized by a shift start time and a shift end time. In additional variations, a shift schedule can be characterized by just a shift start time, and the shift end time can be determined or confirmed at a later time, such as after the shift starts. Still further, the shift start time can be a range, and the shift end time can be determined in part by the personnel and/or their chosen start time within the range. In this way, shifts can be dynamically determined for individual users, or for a class of users.

In addition to shift schedules, the enterprise account information 107 can identify which of its personnel are assigned to which shifts. Further examples provide for the enterprise account information 107 to include or reference relevant profile information for individuals of the enterprise roster, such as (i) known or preferred transport endpoint (e.g., home address, nearest intersection to home address, etc.) of the individual; and (ii) an indication of whether the individual is associated with a restrictive occupancy condition. The enterprise account information can also identify individuals who have designated roles (e.g., chaperon, guard, etc.) for purpose of providing personnel to transport. The enterprise roster can also identify individuals who have additional requirements or preferences (or “constraints”), such as those individuals who require wheelchair accommodations or those personnel who require or prefer singular transport.

As an addition or variation, the relevant profile information for end users of the enterprise roster can be obtained by referencing an identifier of the individual to a pre-existing account that is specific to the user (e.g., personal account). Thus, in variations, the information relating to requesters can be obtained from a user profile store 109, and user profile information can also reference an enterprise account that a requester is associated with.

The enterprise interface 106 can enable an operator of an enterprise account to upload data sets corresponding to the enterprise account information 107. The enterprise account information 107 can identify, for example, a list of personnel for which transport services are available through an enterprise account. As an addition or variation, the enterprise interface 106 can include connectors or other programmatic processes that automatically query an enterprise data source for some or all of the enterprise account information 107. For example, the enterprise interface 106 can include processes that automatically retrieves shift schedules and/or other scheduling information (e.g., shift times, number of persons per shift, and/or identifiers of persons for each shift) from designated enterprise resources. In some examples, an enterprise can enroll in a transport chain service for personnel. During an onboarding process, an administrator can upload the enterprise account information 107, and provide credentials for enabling programmatic retrieval of the enterprise account information on a repeated basis.

In examples, a scheduler 132 includes processes that access the enterprise account data store 108 to generate a chain determination trigger 115 for an enterprise account. The chain determination trigger 115 for a particular enterprise account can be associated with a boundary time, directional orientation and/or common site. The chain determination trigger 115 can include a process that monitors for a predetermined condition or event, and upon the occurrence of the condition or event, initiate a process to generate a group of transport chains based on an aggregated collection of transport job orders. The predetermined condition or event can correspond to a timing condition that precedes the associated boundary time. The timing condition can be an absolute value (e.g., 2 hours before boundary time). The timing condition for the chain determination trigger 115 can also be based on an expected number of transport job orders or vehicles required.

As an alternative or variation, the timing condition for the chain determination trigger 115 can be dynamically determined, based on, for example, the location of the common site and contextual information, such as traffic, weather, time of day, day of week, and/or estimated availability of vehicles for completing the transport chains. In implementation, the chain determination trigger 115 can be defined at least in part by a predetermined interval preceding a known boundary time (e.g., shift start time, shift end time, etc.) for a group of transport chains. During the predetermined interval, the network system 100 can receive the transport requests 101 for the group of transport chains. The termination of the interval can coincide with the timing condition for the chain determination trigger 115. In such case, the chain determination trigger 115 can coincide a cut-off time, after which no further transport requests 101 (if received) are included in the subsequent determination of transport chains. Still further, in some examples, the determination trigger 115 can be based on an update to a dynamically determined shift end time. The update can be provided by, for example, an administrator of the enterprise account, or by individual users who have shift end times that change or are dynamically determined. In the latter case, such users can indicate, via the respective service application running on their device, a time when their shift will be ending.

In additional examples, chain determination trigger 115 can provide for an ad-hoc trigger, such as a manual trigger. An ad hoc trigger can be generated for unexpected or unplanned situations, such as unregistered personnel, unplanned events requiring additional personnel to be transported, system failures, or other situations. When the chain determination trigger 115 is generated by an ad-hoc signal, the arrival or departure times can be determined based on, for example, a predetermined time interval (e.g., within 2 hours) or as soon as possible.

### Requester Interface

Each requester device 102 can execute a service application 116 that communicates a user identifier to the network system 100, where the user identifier uniquely identifies the requester. In additional variations, the user device 102 can communicate an enterprise account, or other third-party account that is associated with the user. In examples, each requester operates the respective service application 116 on their requester device 102 to communicate a transport request 101. Each transport request 101 can identify a requester identifier and a boundary time, coinciding with either a target arrival time at a common site, or a departure time from the common site. Each transport request 101 can also include, or otherwise be associated with requester information, which can include a geographic endpoint, corresponding to a home address or rendezvous location associated with the requester. Additionally, each transport request 101 can include or otherwise reference a shift start or shift end time, as well as an enterprise account and or other enterprise information (e.g., identifier for the common site of the enterprise). In further examples, the requester device can communicate location information, such as can be obtained from a satellite receiver (e.g., GPS component) of the requester device 102.

Further, the processes of the network system 100 can communicate information relating to the requester's transport request to the service application 116 of the requester's device 102. Such information can include the estimated time of arrival of a service provider, the estimated trip duration and information that can enable the requester to identify the vehicle or service provider for the transport chain.

In variations, requesters can transmit transport requests 101 using a web interface, accessible through, for example, a browser. Still further, in other variations, a requester does not have to submit a transport request 101 in order to be provided transport through a transport chain. Rather, the requester can enroll for the transport service through either the network system 100, the enterprise or other third-party. When enrolled through the enterprise, the enterprise account information 107 can identify the requester for specific shifts, and the transport job order determination component 118 can generate transport job orders for such users automatically. For example, prior to each shift starting and/or ending, an enterprise resource can communicate a list of enterprise personnel who have requested to receive the transport request 101.

### Carrier and Provider Interface

Processes, represented by the carrier interface 112, enable an administrator or operator of a fleet of vehicles (i.e., a “carrier”) to communicate with the network system 100. In at least some examples, a carrier can operate a corresponding service application 116A on a carrier device 104A, in order to view and exchange data with the network system 100 via the carrier interface 112. As an addition or variation, the carrier interface 112 can include a web interface that enables a carrier to view and exchange data with the network system 100.

During a setup or configuration phase, a carrier can provide, via the carrier interface 112, information about the vehicles in the carrier's fleet. The information can identify, for example, a total number of vehicles that the carrier has, the number of vehicles that the carrier can make available at different intervals of a day, and/or a seating capacity of each available carrier at each identified interval. In some examples, the carrier can submit a list of vehicles and/or service providers, where each service provider can be separately identified and tracked via a corresponding service application 116B. The carrier interface 112 can maintain vehicle information for multiple carriers or fleets. For a given enterprise account and shift, vehicles from multiple carriers can be used to provide the transport chain services. Moreover, the vehicle information of each carrier can be used to select vehicles, or class of vehicles (e.g., “3-seaters” or “4-seaters”) to fulfill transport chains using vehicles of one or multiple carriers.

Further, in examples, the carrier interface 112 can provide one or more features to enable the carrier to make a commitment as to a minimum number of vehicles and/or seats the carrier can have available for predetermined intervals. For example, the carrier interface 112 can periodically or repeatedly prompt the carrier to update the minimum number of vehicles or seats that the carrier can provide for transport chains during specific time intervals, such as during a time interval that precedes an expected start and end time for a transport chain, or for a group of transport chains.

The provider device interface 114 represents processes for communicating with provider devices 104B. Each provider device 104B can be associated with a corresponding service provider. The service application 116B executing on each provider device 104B can transmit a service provider identifier, as well as the current or recent location(s) of the service provider (e.g., such as may be determined by a Global Positioning System (“GPS”) component or satellite receiver). The service provider can participate in the transport services provided through the network system 100 as either a carrier operator or a service provider. For example, a carrier can identify the service provider as a carrier operator, meaning the service provider has a commitment to provide transport services on behalf of the carrier. Depending on implementation, when the service provider is not operating as a carrier, the service provider can operate as an independent service provider to fulfill, for example, on-demand transport services.

In examples, the provider device interface 114 updates a service provider record with the service data store 130. The recorded information can identify the service provider's current location and the service provider's status (e.g., available, offline, on route to pickup, in progress, etc.).

### Job Order Determination

Based on information included or provided with transport requests and/or enterprise account information 107, processes represented by a job order creation component 118 generate transport job orders 105 for each transport request 101. Each transport job order 105 can identify a service start location, a service end location, and a user identifier. For transport chains, the job orders 105 can also identify a boundary time. Additionally, the job orders 105 can identify a common site that is to serve as the service start or service termination location.

Each transport job order 105 can also be associated with a service type, such as a transport chain type or enterprise transport type. Other types of transport job orders 105 can include, for example, singular transport (e.g., rider requests a transport service just for themselves), pooled transport (e.g., driver picks up additional riders who separately request the transport service, typically with different pickup locations and/or destination locations), bus transport (e.g., driver transports multiple riders in large-capacity vehicle, sometimes while following a pre-determined route), or delivery transport (e.g., service provider picks up and delivers an item).

For transport chains, network system 100 can receive the job orders asynchronously, over a time interval that precedes a cut-off time. For example, transport requests for different types of services can be received continuously. Each transport request can be structured as a job order and stored in a service data store 130. If the job order is for a transport chain type service, the transport job order 105 is pre-associated with a collection of job orders that are to be fulfilled by a group of transport chains. Each job order of the collection can share a common site, boundary time, and directional orientation. In examples, the service data store 130 can aggregate the job orders for the group of transport chains until a designated time is reached, after which the chain determination component 120 determines transport chains for the collection of job orders. In variations, the chain determination component 120 continuously or repeatedly determines new chains, and updates or reconfigures existing chains, in advance of the start time for the transport chains. The chain determination component 120 can make incremental determinations and improvements (or optimizations) to the determined chains. Such variations enable additional flexibility, to allow for situations where, for example, passengers are added after the “cut-off” time, new constraints are identified based on the profile information of the passengers, or other factors.

In some examples, the collection of transport job orders 105 can be aggregated for multiple different groups of transport chains concurrently. The transport job orders 105 for each group of transport chains can each be associated with a common site, a boundary time and a directional orientation in relation to the common site (e.g., arrival or departure, with respect to the common site). Further, each aggregation of transport job orders 105 can be associated with a corresponding set of chain determination triggers.

In some examples, end-to-end transport chains can be determined. An end-to-end transport chain can correspond to a departure chain that follows an arrival chain, where the departure chain and arrival chain have the same common site and about the same boundary time. For an arrival and departure chain to be considered an end-to-end transport chain, the boundary time corresponding to the departure time may be the same, or within a threshold (e.g., 15 minutes) of the boundary time for the arrival chain. An end-to-end transport chain can arise when, for example, an enterprise schedules personnel in adjacent shifts, that personnel for one shift arrive to the enterprise site when personnel for the prior shift are ready to depart. As described, in some cases, an end-to-end transport (departure) chain can be matched to service providers or carriers who have been assigned to the corresponding arrival chain, such that one service provider is assigned to complete two transport chains, back-to-back. In such case, the use of one vehicle improves efficiency of the transport service provided.

According to examples, the scheduler 132 can scan the shift schedules of enterprises to identify adjacent shift schedules, where the end of one shift coincides with the start of another shift. The scheduler 132 can also apply criteria to shift schedules to identify situations for end-to-end transport chains, where for example, the adjacent shift schedules are offset (e.g., one shift starts 30 minutes before another shift ends). The scheduler 132 can apply criteria that sets a maximum threshold for the difference between the shift start time for the arrival transport chain and the shift end time of the outbound transport chain (e.g., 30 minutes). When shift schedules are identified that are adjacent, or otherwise meet the criteria for end-to-end transport chains, the scheduler 132 can generate the chain determination trigger 115 for both the arrival and departure transport chains at one time, along with an indication that the respective transport chains are suitable as end-to-end transport chains. Alternatively, the scheduler 132 can generate the transport chain trigger 115 for the arrival chain, with an indication that indicates the transport chain is suitable as an end-to-end transport chain. The chain determination component 120 can then generate the arrival transport chain with the indication that the transport chain is, or likely is, an end-to-end transport chain, enabling the fleet operator and/or service provider to plan accordingly.

To implement end-to-end transport chains, the scheduler 132 communicates the estimated arrival time for the arrival leg and the estimated departure time for the departure leg to the chain determination component 120. The chain determination component 120 can generate the end-to-end transport chains using the estimated arrival time, the estimated departure time, and the common site. The chain determination component 120 can generate the end-to-end chains at one time, in response to a chain determination trigger 115. Alternatively, the chain determination component 120 generates the end-to-end chain progressively, or iteratively, as the respective shift start and end times approach. For example, each leg of the end-to-end transport chain can be associated with a corresponding chain determination trigger 115, that when signaled by the scheduler, 132 causes the chain determination component 120 to form the respective transport chains, based on the requesters that are known at that time. Further, as the respective shift times approach, the chain determination component 120 can reconfigure the respective transport chains, based on desired optimizations or changes.

In additional examples, the chain determination component 120 generates transport chains for each shift of an enterprise. The scheduler 132 determines when pairs of transport chains for a common site are end-to-end transport chains, based on the transport chains being created for adjacent shifts (or shifts that meet the criteria for adjacent shifts).

### Transport Chain Determination

With further reference to an example of FIG. 1, the chain determination component 120 represents processes for determining a group of transport chains for purpose of transporting a number of persons to or from a common site. The group of transport chains can correspond to multiple transport chains that share a common endpoint and a common boundary time, where the boundary time identifies one of an initiation time or a termination time for each of the transport chains. In some examples, a group of transport chains can also share a directional orientation with respect to the common site (e.g., arrival chains and departure chains). Still further, a group of transport chains can also be associated with a common account, such as an enterprise or third-party account.

The chain determination component 120 can initiate a process to determine a group of transport chains for a collection of transport job orders 105, in response to a trigger or event, such as provided by the chain determination trigger 115. The chain determination component 120 can identify a collection of transport job orders 105 from the service data store 130 that identify or otherwise share characteristics which indicate they are for a same group of transport chains. For example, the transport chain determination component 120 can query for one or more parameters associated with the chain determination trigger 115, such as a group chain identifier, an enterprise account, a shift identifier, a shift time, a common site, a boundary time, and/or a directional orientation with respect to the common site. In this way, the transport chain determination component 120 identify a collection of job orders that are to be fulfilled through implementation of a group of transport chains.

The chain determination component 120 can determine groups of arrival chains and departure chains. For a group of arrival chains, each transport chain of the group can arrange transport for two or more requesters who are to be transported to a common site for arrival during a target time interval that precedes an arrival deadline (e.g., the start of a shift during which the two or more requesters are scheduled to work). The arrival chain specifies multiple geographic endpoints (e.g., pickup locations) and route segments for a transport vehicle to traverse, before transporting the requesters to the common site by or before a boundary time (e.g., target arrival time). For a group of departure chains, each transport chain can provide transport for two or more requesters who are to be transported from a common site to drop off locations that correspond to the individuals home address or designated drop-off points, at a specified departure time (e.g., end of shift). The departure chain specifies multiple geographic endpoints (e.g., destinations or drop-off locations) and route segments for a given transport vehicle to traverse, as the vehicle departs from the common site at a boundary time (departure time) to drop-off each of the requesters individually.

Based on the collection of job orders, the chain determination component 120 generates a group of transport chains, where each transport chain fulfills one or multiple job orders, and where the group of transport chains fulfill all of the collected job orders 105 for the particular site, boundary time and directional orientation. The number of job orders associated with each transport chain can be based on a variety of factors, including a desired or expected occupancy per vehicle, which may be based on the vehicles being used having a set number of seats for carrying passengers (e.g., four or six seats).

As an addition or variation, an enterprise account can be provided a limit as to the number of personnel that can be transported with transport chains at specific time periods (e.g., at a particular shift). In situations where, because of a predetermined limit, there is an insufficient number of transport chains to transport all requesters, the network system 100 can (i) implement, on an ad-hoc basis, an increase in the number of transport chains and/or providers; (ii) provide or arrange alternative transport for personnel, such as singular or pooled transport, through the network system 100; and/or (iii) provide vouchers for the personnel to obtain transport through a third-party or public service.

In examples, each transport chain can be based on a combination of job orders, where each job order identifies a geographic endpoint for the transport chain. For example, an arrival chain can identify multiple pickup locations (e.g., between two and six pickup locations), a common destination (e.g., site location for an enterprise) or set of common destinations (e.g., enterprise with multiple locations), and a boundary time, defining a time interval when the transport chain terminates. Similarly, a destination chain can identify multiple destination locations, a common start location (e.g., site location for an enterprise), and a boundary time defining a start to the transport chain. Further, as described with some examples, the boundary times for the transport chains can be based on predetermined schedules, such as shift schedules for an enterprise operating at the common site. For example, a boundary time for an arrival chain can be based on a shift start time. A boundary time for a departure chain can be based on a shift end time.

Each transport chain can also associate the geographic endpoints with a sequence and/or a service time. For an arrival chain, the sequence can identify the order in which each pickup occurs at a corresponding pickup location. For a departure chain, the sequence identifies the order in which each destination occurs. The service time for each endpoint can estimate the pickup time or the destination time.

Each transport chain can also be associated with a suggested or planned route. A mapping service 138 can be used to determine the routes, as well as the time or distance of travel between geographic endpoints of a transport chain. The time and/or distance of travel can be used to determine the service time for each geographic endpoint of a transport chain.

The determination of transport chains can also be subject to a set of one or more predetermined constraints 127. As described in more detail with examples, the predetermined constraints 127 can include rules that define conditions under which transport chains can be invalid. As an example, a predetermined constraint 127 can include a rule where if a defined inconvenience metric for a transport chain exceeds an inconvenience threshold for any requester, then the transport chain is invalid. As an example, a predetermined constraint 127 can include a rule where if a particular occupancy condition is deemed to be present along any portion of the transport chain, then the transport chain is invalid.

In examples, the predetermined constraints 127 can define threshold parameters for individual transport chains. For example, constraints can specify (i) a maximum duration or distance of travel for a transport chain to be completed, (ii) a maximum duration or distance of transport for a requester, and/or (iii) a maximum time interval or distance of inconvenience to any requester, when a transport chain is implemented. The latter limitation can be based on an inconvenience metric, which measures additional time or distance to the requester as a result of route deviations to accommodate the other requesters of the transport chain. The inconvenience metric can be relative to a point of reference, such a singular direct travel. By way of illustration, a constraint can be defined as a limitation against including a requester in a transport chain if the estimated time or duration for the requester's transport by transport chain would exceed the estimated time/distance for transporting the requester directly to or from a common site by more than a predetermined threshold.

To determine whether inconvenience metric is violated, the chain determination component 120 can use a map service 138 to calculate a duration or distance of travel, given route and traffic conditions. The inconvenience metric can be calculated for each requester/endpoint of the transport chain.

An occupancy constraint can be defined by a restrictive occupancy condition that, when present, precludes certain requesters from being an occupant of a transport vehicle. Requesters that can be subject to an occupancy constraint can be associated with a categorical designation, also referred to as a restrictive parameter. A restriction parameter can be implemented as a parametric value associated with a requester profile or transport request. By default, the restriction parameter can reflect a value where no restriction condition is specified with the requester unless a determination is made otherwise, based on requester input, requester profile information, or input from the enterprise or other source. The restriction parameter can be implemented as, for example, a binary value that indicates whether or not a restrictive occupancy condition is to be applied to transport services provided to the user. The restriction parameter can also be determined from an attribute (or attributes) of the user's profile, such as gender or age. A restrictive parameter or occupancy constraint can be based on legal requirements of a geographic region where the transport is being provided, as may be defined by laws, regulations, ordinances or other authoritative sources. A restrictive parameter or occupancy constraint can also be a requirement as defined by an enterprise account holder, or an affiliate entity of an enterprise (e.g., union).

In some examples, a restrictive parameter corresponds to a demographic characteristic (e.g., gender, age, etc.) of a requester. By way of example, an occupancy constraint can specify that a certain requesters may require a guard or safety guarantee, meaning those requesters cannot be a sole passenger of a vehicle. In such case, the restrictive parameter can be based on a gender of the requester, which can be determined from the requester's profile information or input. In a variation, the occupancy constraint can be subject to additional conditions, such as timing parameters that define when the occupancy constraint is active or in force. For example, the occupancy condition can specify that a woman cannot be the sole passenger of a vehicle after sunset, or during a period of time (e.g., 7 pm to 7 am). Still further, the occupancy condition can be specific to other conditions, such as a characteristic of the service provider or the vehicle. For example, an occupancy condition can be specific to (i) a gender, age or other demographic characteristic of the service provider, (ii) to a qualification or certification of the service provider, (iii) a type of vehicle, and/or (iv) the use or availability of specialized equipment within the service vehicle. In some examples, when a transport chain is deemed invalid as a result of violating a constraint, then a corrective action can be taken to reconfigure the transport chain so that is not violative. Further, an iterative process can be implemented to cure transport chains that are otherwise deemed invalid for failing meet a constraint. In the case where an inconvenience metric for one or more of the requesters is violated, the chain determination component 120 can reconfigure the transport chain by, for example, resequencing the endpoints of the transport chain so that the inconvenience constraint is not violated for any of the requesters. As an addition or variation, the route to transport one or more of the requesters in the transport chain can be altered so that the inconvenience metric is not violated.

When an occupancy constraint is violated, examples provide for the chain determination component 120 to make a determination as to whether resequencing the endpoints of the transport chain can avoid the constraint violation. If re-sequencing cannot eliminate the constraint violation, then the chain determination component 120 can include a designated personnel (e.g., guard) in the vehicle to prevent the violation of the transport request. This can be done by adding an endpoint to the transport chain, where the endpoint is associated with the location of the designated personnel. In the case of an arrival chain, the designated personnel can be the first pickup (e.g., from their home or other associated location). In a departure chain, the designated personnel can be the last drop-off. Further, in examples, when a designated personnel is added to a transport chain, the inconvenience metric for each requester of the transport chain can be determined again to ensure the reconfigured transport chain does not violate an inconvenience metric.

In examples, if it is not feasible to correct a transport chain so that is does not violate a constraint, then in variations, job order (or endpoint) that is the source of the constraint violation can be removed from the transport chain and matched separately to an on-demand transport. For example, the job order for the excluded requester can remain in the service data store 130 as a scheduled job, and subsequently, the job order can be matched to a service provider through implementation of a driver/requester matching process, implemented by the matching component 140.

### Group Transport Chain Optimization

The transport chain determination component 120 can implement optimization logic 122 to optimize the transport chains based on a set of group-level objectives. The optimization logic 122 can define a cost function for the group of transport chains, where the cost function can be based at least in part on a set of group-level metrics. In examples, the group-level metrics can include the number of vehicles used to complete the transport chains of the group (without violating any constraints). As an addition or variation, the group-level metrics can include (i) a total summation, or average thereof, of the distance or duration of travel for the group of transport chains; and/or (ii) a total summation, or average thereof, of the distance or duration of travel for fulfilling each job order identified with each transport chain of the group; and/or (iii) an average of the distance or duration of travel for the transport chains that comprise a group.

In examples, the chain determination component 120 configures the group of transport chains to minimize the cost function. Each transport chain of the group can be configured with geographic endpoints of requesters (corresponding to job orders) to optimize the group level metrics, and minimize the cost function. In one implementation, the pickup or drop-off locations of all the job orders that are to comprise the group of transport chains is distributed about the common site on a spatial representation. Each of the pickup/drop-off locations are associated with a spatial region, based on a group-level metric of the cost function. For example, the spatial region can be defined as a ring, representing, for example, an average travel duration to the common site. The pickup/drop-off locations that are in the same ring can be grouped into corresponding sets of transport chains. If a transport chain can include additional pickup/drop-off locations from other rings, then pickup/drop-off locations from the next closest ring is selected. The selection and configuration of the spatial regions can be based in part on the metrics used with the cost function. For example, if the cost function prioritizes the minimization of inconvenience, then the chain determination component 120 can identify clusters of pickup/drop-off locations, as configuring transport chains for such clusters also minimizes the inconvenience metric as a whole.

In grouping pickup/drop-off locations by spatial regions, simulated transport chains with different combinations of endpoints can be determined for analysis. The analysis can include constraint and optimization analyses. In the constraint analysis, each of the simulated transports chain is analyzed to determine whether any constraints (e.g., inconvenience metric, restrictive occupancy constraint) are violated. If any simulated transport chain is determined to violate a constraint, then the chain determination component 120 can either (i) discard the transport chain from further consideration; (ii) attempt to reconfigure the transport chain so that it does not violate a constraint, such as by re-sequencing the transport chain or by substituting an endpoint from another ring; (iii) add or configure the transport chain with corrective action, such as include a designated personnel in the transport vehicle when a restrictive occupancy constraint is violated; and/or (iv) provide alternative transport for individual job orders that cause any one of the transport chains to violate a constraint.

In examples, the chain determination component 120 can optimize a group of transport chains in situations where a restrictive occupancy constraint is in force, by (i) minimizing the occurrence of transport chains that are subject to an occupancy condition, and/or (ii) applying the cost function to transport chains which have been reconfigured or subject to corrective action to address the existence of a condition that is not permitted by the restrictive occupancy constraint. In examples, the optimal set of transport chains is determined, and if a restrictive occupancy condition exists for any of the transport chains in the selected group, additional measures are provided so that the transport chain complies with the restrictive occupancy condition. These additional measures can include, for example, adding a designated personnel to the transport vehicle of the transport chain that is subject to the restrictive occupancy condition.

In variations, the transport chain determination component 120 simulates each possible configuration for the group of transport chains, including each possible combination of endpoints in every possible sequence. The result of the initial step is a simulated set of groupings, where each grouping includes a number of transport chains. Constraint analysis is performed on the transport chains of each grouping of the simulated set. If any of the transport chains of a simulated grouping is deemed to violate a constraint, then the grouping as a whole is discarded from further consideration. After constraint analysis is performed, only groups of transport chains which do not violate a constraint remain. The optimization analysis can include determining the cost function for each remaining group of transport chains. The simulated group of transport chains which minimize the cost function can be selected for implementation.

In additional variations, the chain determination component 120 generates and configures the group of transport chains by determining sub-groups of transport chains. The transport job orders 105 that are to be serviced by the group transport chain can be segmented by, for example, geographic subregion of the requesters. The chain determination component 120 can employ different conditions for segmenting the job orders. For example, job orders can be clustered by the locations of the requesters. The clusters can correspond to neighborhoods, quadrants, or general direction of travel with respect to the common site (e.g., requesters who live north of the common site, requesters who live south of the common site). Each cluster can be sized based on the computational resources available and/or the time interval in which the group transport chain is to be determined and configured. Once the clusters are determined, the chain determination group 120 can determine each possible configuration of transport chains for individual clusters, including for each possible combination of endpoints and every sequence of the given cluster.

As an addition or variation, a meta-heuristic optimization approach can be implemented to determine the group of transport chains. The determination can be nondeterministic and iterative, such that groupings (or subgroup) of transport chains are determined over a given time interval, with portions of the group being determined once an initial set of transport chains are determined. Further, under such approaches, the groupings of transport chains can be refined, with processes that continually examine and modify the solution space of determined transport chains. In some examples, the problem of determining a group transport chain is localized, such as when the transport chains are identified for subgroups of the job orders. In such examples, the optimization of the cost function is localized, for clusters or subgroupings of job orders. While the determined subgroup of transport chains may not be the combination that is most optimal (e.g., the combination that corresponds to the absolute minimization of the cost function), the localized group of transport chains can be optimal, or near optimal, for the sub-group. As such, the localized subgroups of transport chains can be considered an optimized solution for the larger group of transport chains, because the subgroups of transport chains are intelligently configured to reduce the cost function as compared to a scenario where the transport chains are determined independent of the considerations of the cost function.

In a variation, after constraint analysis is performed on each simulated grouping of transport chains, if any of the transport chains are deemed to violate a constraint, then the violative transport chains can be reconfigured (if possible) to not violate the constraint. In the case where a transport chain in a simulated grouping is deemed to violate a restrictive occupancy constraint, then that transport chain can be reconfigured to include a corrective action - such as the inclusion of a designated personnel (e.g., guard) as an additional passenger/endpoint. The optimization analysis can then be performed on the remaining groupings of transport chains, where the remainder group can include those groups which have transport chains which are reconfigured to correct for a restrictive occupancy condition.

Further, if there are multiple mechanisms to address a constraint (e.g., restrictive occupancy constraint), then a separate grouping of simulated transport chains can be created for each possible configuration of the violative transport chain, and the cost function for each variant to the simulated group of transport chains can be separately determined and considered. Examples provide that through simulation of the possible permitted configurations for the group of transport chains, the transport chain determination component 120 can implement the optimization logic 122 to determine, from the simulated groups of transport chains, the particular group of transport chains that minimize the cost function, where the selected group of transport chains identifies (i) each transport chain, and (ii) each endpoint of each transport chain. Additionally, the selected group of transport chains can also identify a sequence amongst the endpoints of each transport chain.

Still further, the chain determination component 120 can identify a group of transport chains that can transport all of the transport job orders 105 without violating any of the constraints, but through application of the cost function, the chain determination component 120 reconfigures the group of transport chains such that one or more transport chains violate a constraint and require corrective action. The reconfiguration can be based on calculation of the cost function for the scenario where no constraints are violated versus one where the constraint is violated and requires corrective action. In the latter case, if the cost function includes the cost of the corrective action, but is still less than the solution where no constraint is violated, then the latter solution may be implemented.

### Group Transport Chain Data Set

Once the configuration for the group of transport chains is determined, the transport chain determination component 120 can record a group of transport chain records 121 with the service data store 130, where each transport chain record 121 of the group is associated with, or otherwise references its own identifier, as well as a group identifier 121A or record. Accordingly, each transport chain record 121 of the group can associate a group identifier 121A with its own identifier. Additionally, each transport chain record of the group can reference one or multiple transport job orders 105 that are included in the transport chain. Each transport chain record 121 can also include information that is descriptive of the corresponding transport chain. The descriptive information can include, for example, (i) a number of passengers, (ii) a start location (for arrival chains) or end location (for departure chains) of the transport chain, (iii) each geographic endpoint of the transport chain, and (iv) an identifier of each requester that is associated with one of the geographic endpoints of the transport chain. In some variations, the descriptive information can also identify whether a restrictive occupancy condition is present over any portion of the transport chain, and/or whether designated personnel for avoiding the restrictive occupancy condition are included in the transport chain.

In examples, the mapping service 138 can supplement information provided with each of the transport chain records 121 of the group. The mapping service 138 can provide, for example, information as to the estimated arrival time of the transport chain at each endpoint, as well as at the common site (for an arrival chain). As described with some examples, the mapping information (e.g., estimated duration of travel to geographic endpoint of each requester, estimated time of arrival to common site, etc.) can be communicated to the requester devices 102 and provider devices 104B, via respective requester interface 110 and provider interface 114. The mapping service 138 can also determine routes for each segment of the transport chain, based in part on traffic conditions, fuel efficiency and travel time. The route information can be communicated to the provider devices 104B via the provider interface 114.

### Carrier Matching and Driver Assignment

In one example, the network system 100 implements a set of processes represented by a matching component 140 to match a group of transport chains to a carrier. The matching component 140 can select one of multiple carriers for a group of transport chains based on parameters that include (i) a number of available vehicles each of the multiple carriers has available for the group of transport chains, and/or (ii) a total seating capacity of each of the multiple carriers. Other parameters that can influence the selection of the carrier can include a type of vehicles provided by the carrier, a proximity of the carriers'vehicles to the common site, and/or historical performance records of the carrier. The matching component 140 can select the carrier with, for example, the closest available seating capacity, or the carrier that has the greatest number of seats per vehicle. The determination of the number of available vehicles and/or seating capacity can be based on input declaration from the carrier. In variations, the carrier vehicles or service provider capacity can be verified through communication with corresponding provider devices 104B, via the provider interface 114.

In examples, the carrier interface 112 provides a graphic representation 135 of a group of transport chains for a selected carrier. The graphic representation 135 can be generated on, for example, a carrier device executing a service application 116A. The graphic representation 135 can enable the carrier to view information about each transport chain of the group. In additional examples, the graphic representation 135 can be interactive, or made part of an interactive carrier interface 137A (e.g., via the service application 116A) to enable a carrier to provide input that can select service providers or vehicles for each of the individual transport chains of the group. In additional examples, an interactive provider interface 137B can be provided through the service application 116B, to enable individual service providers to accept an assigned transport chain.

In further examples, the interactive carrier and/or provider interface 137A, 137B can also enable the respective carrier and/or service provider to modify or create new transport chains, responsive to, for example, the number of requesters, the number of available vehicles or service providers, the ability of the available service providers and/or the capacity of the available vehicles. For example, the carrier can modify an initial group of transport chains by splitting a transport chain, originally configured for 4 passengers, to two transport chains that are 2 passengers each. The carrier can make the modification because the carrier lacks a vehicle for transporting 4 passengers, or because if the original configuration is maintained, a guard may be otherwise required (e.g., such that there may be 5 passengers). The ability of the carrier or service provider to modify or create transport chains can be subject to constraints 127 implemented by the chain determination component 120. For example, if the creation or modification of a transport chain causes the transport chain to exceed an inconvenience metric, then the creation/modification may be programmatically disallowed by the network system 100.

The carrier device 104A can communicate to the network system 100, via the carrier interface 112, the assignment of service providers to individual transport chains. In such examples, the network system 100 does not match transport providers or vehicles to transport chains. Rather, a group of transport chains are assigned to a carrier, and the carrier assigns each transport chain to a driver. The assignment of each driver to one of the transport chains can be recorded, by, for example, the carrier device 104A and the carrier interface 112. Each transport chain record 121 of the group can be updated to associate the identifier of the carrier with that record. Further, each transport chain record 121 can be updated to reflect a driver identifier for each transport chain of the group, as well as the status of the job order 105. In this way, the service data store 130 can associate each transport chain record with an identifier of each service provider. The network system 100 can also provide real-time notifications to the service provider devices 104B and monitoring component 134. Further, the status of the respective job order(s) can also be changed to reflect the assignment of the driver, as well as subsequent progress.

### Service Provider Matching

While some examples provide that carriers assign service providers to transport chains, in variations, the matching component 140 can assign individual drivers to one or more transport chains of a group. For example, if a carrier does not have enough vehicles or capacity for all of the job orders in a group, then the matching component 140 can implement a matching process to match a service provider to an individual chain of the group. Alternatively, the network system 100 can be configured to match service providers to transport chains, rather than groups of transport chains to carriers.

The matching component 140 can select a service provider for an individual transport chain based on one or more criteria that includes an availability of the service provider over a duration that encompasses the expected completion time for the transport chain. For a group of transport chains, the matching component 140 implements a separate matching process for each transport chain of the group. In performing the matching process, the matching component 140 can scan the service data store 130 for candidate service providers. Candidate service providers can include those service providers for which there is a high expectation of availability. The determination of availability for service providers can be based on, for example, (i) a current status of the service provider (e.g., whether the service provider is currently providing transport service), (ii) an indication of the service provider being available for a duration that encompasses the completion time for the transport chain (e.g., service provider sets their time of availability in advance through the service application 116B), and/or (iii) a current location of the service provider, relative to the first stop or endpoint of the transport chain. The matching component 140 can identify a set of candidate service providers, and perform a matching process based in part on the service provider availability. Once a service provider is matched to a transport chain, the matching component can cause an invitation to be communicated to the service provider device 104B, and if the service provider accepts, the service provider is assigned to the particular transport chain. Each transport chain record 121 of the group can associate an identifier of the matched service provider with the corresponding transport chain.

Still further, in other variations, the matching component 140 can implement a matching process to select a service provider for a transport chain, independent of any association between the service provider and a carrier. The matching component 140 can scan records of service providers in the service data store 130, to identify service providers who have made a commitment to be available for a transport chain. The matching component 140 can also verify the service provider's availability for a transport chain during an upcoming time interval, based on a current location of the service provider and/or a service status of the service provider. Based on the availability and other parameters such as the seating occupancy of the service provider's vehicle, the matching component 140 can match a service provider to a transport chain. Once matched, the corresponding transport chain record 121 can be associated with a record of the service provider.

### Transport Chain Implementation

As described with examples, the service data store 130 can maintain an identifier or record of each service provider that is assigned to one of the transport chains of a group. For example, each of the transport chains 121 of the group can be updated to reference, or otherwise associate the transport chain record with a corresponding service provider identifier, based on a carrier designation and/or provider matching process.

During an interval preceding the start of a transport chain, processes represented by monitoring component 134 can track a progress and arrival of a service provider to a starting point of a transport chain, where the starting point is one of an endpoint (for arrival chain) or the common site (for departure chain). The monitoring component 134 can communicate with provider device 104B and/or requester device 102, to obtain their respective location information before and/or during a corresponding transport chain. On the requester device 102, the service application 116 executes to obtain location information from a location-aware resource of the device (e.g., GPS component), and to repeatedly (e.g., at periodic intervals) communicate the location information to the network system 100 via the requester interface 110. The requester interface 110 can update the service data store 130 with the requester location. Similarly, on the provider device 104B, the service application 116B executes to obtain location information from its location-aware resource (e.g., GPS component), and to repeatedly communicate the location information to the network system via the provider interface 114. The provider interface 114 can update the service data store 130, to indicate the current location of the service provider. In this way, each transport chain record 121 can be associated with (i) identifiers of the requesters (e.g., by account identifier) that are to be or being transported in that transport chain, (ii) the current location of each requester that is matched to the corresponding transport chain, including those requesters that are currently being transported or awaiting to be picked up, (iii) the identifier of the service provider or vehicle providing transport, and (iv) the current location of the service provider or vehicle providing transport. In variations, the transport chain records 121 can also identify constraints that affect the manner in which the transport chain is performed or completed, including the presence of restrictive occupancy conditions by any of the requesters. The transport chain record 121 can indicate, for example, whether a guard or chaperone is required for the chain, an identifier of the guard or chaperone, and the current location of the guard or chaperone.

Just prior and during the performance of transport chain, the monitoring component 134 can communicate with the service data store 130 to determine updated information about the transport chain. The monitoring component 134 can communicate with the provider device 104B to signal when the service provider should initiate the transport service by traveling to the first stop of the transport chain. The monitoring component 134 confirms the progress of the service provider to the first stop, and each successive stop thereafter. The monitoring component 134 can also communicate the current location of the service provider to each requester device 102 prior to their pickup. The monitoring component 134 utilizes a mapping service to estimate the travel/arrival time of the service provider at each stop, and the respective arrival times can be communicated to each requester device before they are picked up. Further, after pickup, each requester device 102 can also receive an updated estimated arrival time to the destination.

In examples, prior to a requester entering a vehicle, the monitoring component 134 can communicate a code or other identifier to the provider device 104B. The code can be, for example, an optical code (e.g., a QR code), numerical code (e.g., pin code) or textual (e.g., password). The provider device 104 can also be provided information about each requester, such as a first name, or an image, to enable the provider to identify the requester for the transport chain.

As an addition or variation, for a given transport chain, the monitoring component 134 can also provide, via the requester interface 110, each requester device 102 of a transport chain with a respective identifier. As with the provider device, the respective code can correspond to, for example, an optical code (e.g., QR code), pin code, password or similar mechanism to identify the transport chain. Before entering a vehicle, the requester and the service provider can exchange their respective codes by, for example, displaying their respective optical code (which can be verified by scanning the optical code using a camera) or visual code (which can be verified by sight) to one another. Each requester device 102 can also receive information that identifies information about the service provider and/or transport vehicle.

In variations, the monitoring component 134 can enforce conditions with respect to enabling a transport provider or vehicle to transport riders. For example, in some embodiments, when a vehicle is required to include a guard or chaperone for a particular passenger, the provider may be required, via the service application 116B, to “check in” a guard or chaperone. The check-in may be implemented in part by the guard or chaperone being provided a digital identifier that can be rendered as, for example, an optical code on their device. utilize their computing device. The guard or chaperone may render their optical code to the service provider to verify their identity or role. The provider can scan the code using the provider device 104B, and the service application 116B can transmit information for verifying the guard or chaperone Once verified, the condition of the monitoring component 134 can be met. In examples, the service provider can be precluded from initiating or progressing until the check-in of the guard or chaperone. For example, once the monitoring component 134 determines the condition is met, the provider device 104B is provided navigation instructions to initiate or progress to a next location of the transport chain (e.g., drive to first or next pickup or destination).

As mentioned, the monitoring component 134 can provide each requester device 102 with information about the progress of the transport chain, including the predicted arrival time of the requester to either the common destination or their respective geographic endpoint. Likewise, the monitoring component 134 can provide the provider interface 114 with information about the transport chain, including an expected completion time. Additional information, such as a planned or anticipated route, and the endpoints of the transport chain, can also be made available to the provider via the provider interface 114. As the transport chain progresses, the provider device 104B can, for example, update the transport chain record 121 with the service data store 130, to update for current location of the associated provider or vehicle. In turn, the mapping service 138 can update the information about predicted arrival times and estimated completion time can be updated and communicated to the respective requester and provider devices 102, 104B.

Further, in examples, the location information of the provider device 104B, as well as the requesters 102, over the course of the time interval when the transport chain is being performed, can be recorded with the transport chain record 121. Subsequently, the transport chain record can be archived, to enable the auditing as needed.

### End-to-End Transport Chain Matching

As described, the transport chain determination component 120 can identify when an arrival chain and departure chain for a common site qualify as an end-to-end transport chain. The determination can be made based on a comparison of the boundary time for the arrival chain and the departure chain. If the boundary time for the departure chain is within a threshold time interval (e.g., 15 minutes) of the boundary time for the arrival time, then the arrival and departure chain can be identified as end-to-end transport chains. The matching component 140 can match, or weight in favor of matching, the end-to-end transport chains to the same carrier and/or provider, such that one vehicle is used to complete both transport chains. Further, the matching of a carrier or provider to the arrival chain can be based in part on an ability of one provider to fulfill the departure chain. Thus, the end-to-end transport chains can be matched such that one service provider and vehicle completes both transport chains.

### Methodology

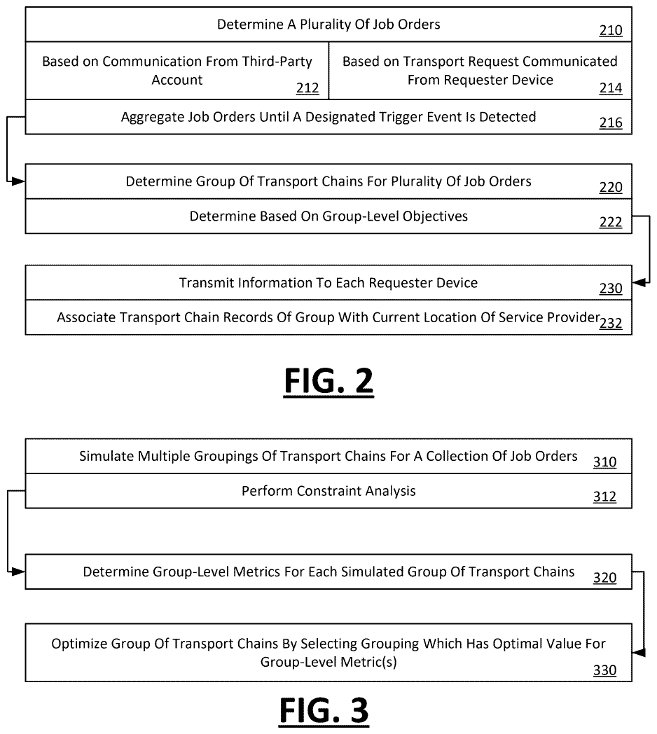

FIG. 2 illustrates an example method for a network system to implement a group of transport chains, according to one or more embodiments. FIG. 3 illustrates an example method for enabling a network system to optimize a group of transport chains, according to one or more embodiments. In describing examples of FIG. 2 and FIG. 3, reference is made to elements of FIG. 1 for purpose of illustrating suitable components or functionality for performing a step or sub-step being described.

With reference to FIG. 2, network system 100 determines a plurality of transport job orders 105, where each transport job order 105 corresponds to a record, generated to transport the requester to or from a common site (210). Accordingly, each transport job order 105 can be stored in the service data store 130 and associated with a user identifier and a corresponding endpoint. Each transport job order 105 can be associated with or otherwise reference information about the requester, the transport request, the common site, and the boundary time. Further, each transport job order 105 can also indicate a directional or time-based orientation for the job order, indicating whether the job order is for an arrival or departure with respect to the common site.

In examples, each transport job order 105 can be based on, or otherwise correspond to a transport request communicated to the network system 100 from a requester device 102 (214). The network system 100 can receive transport requests for a geographic region continuously, and for each transport request, the network system 100 can generate a corresponding transport job order 105. The network system 100 can use information included with the transport request to associate individual transport requests as a chain type request. Each chain type request can be associated with a set of resources and/or information, such as a third-party account, a shift schedule, a list of users that are to be serviced through a group of transport chains, and a common site that uses information specified with the transport request to match the requester with a corresponding enterprise account.

In variations, each transport job order 105 can be based on information communicated from a third-party account, such as an enterprise account (212). In an example, the network system 100 can retrieve a list of requesters for scheduled times from an external source. The network system 100 can periodically retrieve a list of requesters for transport to or from a common site, based on a predetermined schedule. For example, an enterprise can publish or make available a shift schedule, along with personnel working each shift, and the network system 100 can generate job orders for at least some of the personnel automatically, by periodically retrieving or receiving the shift schedules and identifying personnel for each scheduled shift.

In some examples, the network system 100 can aggregate transport job orders 105, as may be stored with the service data store 130, for a group of transport chains until a designated trigger event (216). The designated trigger event can be based on a predetermined schedule. For example, in the case of a shift schedule, the chain determination trigger can be based on a start and an end time for each shift of the shift schedule. The aggregated collection of transport job orders 105 can reflect multiple groups of transport chains. For example, the network system 100 can group job orders by boundary time and by directional orientation (e.g., arrival or departure, with respect to the common site). As described, an aggregation of transport job orders 105 can be processed at one time to generate multiple transport chains, from which one or more groupings can be identified based on, for example, optimization objects.

In examples, a group of transport chains is determined from the aggregation of transport job orders 105 (220). The network system 100 determines a group of transport chains based on the plurality of job orders, where the group of transport chains share a common endpoint and boundary time (220). The common endpoint can correspond to either a chain termination point or a chain initiation point. The boundary time can correspond to a target arrival time (at a termination point), or a departure time (from a chain initiation point). Further, each transport chain can identify or correspond to one or more of the plurality of job orders, such that when a transport chain is completed, each job order of that transport chain is fulfilled. The group of transport chains can be determined by generating multiple transport chains, where each transport chain is represented by a corresponding transport chain record 121 stored in the service data store 130, and where the group of transport chains is represented by referencing or associating the corresponding transport chain records 121 with a corresponding group identifier or group record. In this way, a group of transport chain records 121 can collectively represent transport chains of a group, where each transport chain is represented by a corresponding transport chain record to transport multiple requesters of a group of requesters.

In examples, an arrival chain provides for transporting requesters to a common site, for arrival during a target time interval that precedes an arrival deadline (e.g., the start of a shift during which the two or more requesters are scheduled to work). For arrival chains, each transport chain record specifies multiple geographic endpoints (e.g., pickup locations) and route segments for a transport vehicle to traverse to pickup each requester, before transporting the requesters to the common site by or before a boundary time (e.g., target arrival time). As another example, a departure chain can arrange transport for two or more requesters who are to be transported from a common site to drop off locations that correspond to the individuals home address or designated drop-off points. For departure chains, each transport chain record specifies multiple geographic endpoints (e.g., destinations or drop-off locations) and route segments for a given transport vehicle to traverse to drop-off the requesters, with the vehicle departing from the common site at a boundary time (departure time) to drop-off each of the requesters individually.

In examples, the determination of the boundary time, as well as the orientation of the transport chain as being an arrival or departure chain, can be determined independent of information contained in the transport request. The network system 100 can access the enterprise data store to determine shift schedules that are associated with the common site. The transport chain determination component 120 can use an identifier of the requester to determine the requester's shift schedule. By referencing the requester identifier with the shift schedule, the job order for the requester can be associated with a boundary time and also a directional orientation (i.e., arrival to or departure from common site).

In examples, the group of transport chains are determined based at least in part on one or more group-level objectives (222). The group-level objective can correspond to an optimization of an aggregation to a metric for each transport chain of the group, where the metric represents a desired characteristic for any given transport chain. In some examples, the metric can correspond to a distance or duration of travel for a transport chain, and the group-level metric can include a summation or average (e.g., mean, median, mode, weighted mean, etc.) of the distance or duration of travel for all of the transport chains in the group. In variations, the metric can correspond to a distance or duration of travel for each endpoint (i.e., requester pickup or drop-off location), or alternatively, an aggregation of the distance or duration of travel for the chain as a whole (e.g., chain-level aggregation). In such cases, the group-level metric can include a summation or average (e.g., mean, median, mode, weighted mean, etc.) for all of the job orders that are fulfilled by the group of transport chains.

Based on the group-level metric as described, the group-level objective can include, for example, minimizing one or more of the following: (i) a total summation or average of the distance or duration of travel for the group of transport chains; (ii) a total summation or average of the distance or duration of travel for fulfilling each job order identified with each transport chain of the group; and/or (iii) a total summation or average of the distance or duration of travel for each transport chain of the group.

As an addition or variation, the group-level objective can include minimizing a number of transport chains (or transport vehicles) that are generated, based on a known or estimated seat occupancy of the available vehicles.

By way of illustration, the network system 100 selects a configuration for the group of transport chains, where the total distance (or time of travel) for all of the transport chains combined is minimized. As another example, the selected configuration for the group of transport chains can be the one where the average chain completion time is minimized.

The network system 100 transmits, over a network(s), information about each requester's job order to their respective device 102 (230). The information can identify the vehicle or service provider for the chain, to facilitate the requester in finding and entering the correct vehicle. In some examples, the information communicated to each requester device 102 can be coded. For example, the network system 100 transmits data to each requester device, to cause the service application 116 on the requester device 102 to display a code (e.g., optical code, such as QR code, numeric or pin code, etc.) to enable optical recognition by another device (e.g., driver device 104B). The driver can, for example, execute the service application 116B to scan a code (e.g., QR code) provided by the requester device 102 to confirm the requester is in the correct vehicle. For example, the driver device 104B can be provided identifiers of each passenger that is to be transported in a particular transport chain in advance, and the service provider can visually confirm that each requester is entering the correct vehicle. As another example, each service provider 104B can execute the service application 116B to scan or read in the code communicated by the requester or requester device, and the service application 116B of the provider device 104B can communicate with the network system 100 to determine whether the requester is to be transported by the service provider.

In examples, the network system 100 associates each transport chain record 121 for a group of transport chains (232) with a current location of the service respective service provider. The network system 100 can obtain information regarding the progress or status of each transport chain. As described with examples, the monitoring component 134 can track a current location of the service provider of each transport chain, and the corresponding transport chain record 121 can be updated to reflect a status or state of the transport chain based on the current location of the corresponding service provider. As another example, the service provider can be associated with a service provider record that is updated to reflect the current location and/or status of the service provider. At the same time, a corresponding transport chain record that references the service provider's record can be updated automatically. In turn, requester devices 102 can receive updates to their respective service requests. In this way, updates to a transport chain can be effectively communicated through monitoring of a service provider, and updating one or more records associated with the service provider.

With reference to FIG. 3, examples provide for the network system to simulate multiple groupings of transport chains for a collection of transport job orders (310). The collection of transport job orders can be characterized as having a common site, directional orientation and boundary time. Multiple groups of transport chains can then be generated as a simulation, with each simulated group representing a possible configuration for the group of transport chains. The simulated group of transport chains can include different possible combinations of endpoints (or requesters), as well as different sequences of endpoints. In some examples, the simulated groupings of transport chains identifies every possible combination of endpoints, in every possible combination, for the collection of job orders.

For each simulated group of transport chains, metrics for a group-level objective are determined. The group level objective can correspond to an aggregation of the duration or distance of travel to fulfill each job order, where the aggregation can reflect a summation, an average, a median etc. as an addition or variation, the group-level objective can correspond to an aggregation of the duration or distance of travel to fulfill each transport chain of the grouping, where the aggregation corresponds to a summation, average or median of the distance or duration of travel for completing each transport chain. In this way, the network system 100 can select the grouping a transport chains having a configuration that is optimized based on the group-level objective.

In some examples, when determining the group of transport chains, the network system 100 can also use data corresponding to account constraints that preclude individual transport chains from having a particular configuration or set of configurations (312). This can include avoiding configurations for groupings of transport chains, where any one of the transport chains violates a constraint. In a simulated grouping of transport chains, if a constraint precludes the implementation of a particular transport chain, then the transport chain determination component 120 can omit the simulated grouping for which the offending transport chain was generated. As an illustration, if a simulated grouping of transport chains includes ten transport chains, each of which include three requesters, and one of the groupings is determined to violate a restrictive occupancy constraint, then the simulated grouping of ten transport chains is ignored from the set of possible groupings.

In a variation, when simulating possible configurations of transport chains, rather than preclude a configuration for a grouping of transport chains were one or more transport chains violated constraint, the network system 100 can alternatively seek to re-configure individual transport chains to avoid the constraint. For example, if one transport chain in a grouping of ten simulated transport chain violates a restrictive occupancy constraint, then the network system 100 can attempt to reconfigure the particular violating transport chain in that simulated grouping, such that none of the transport chains in the simulated group violate a constraint. For example, a restrictive occupancy condition can state that a passenger with a particular restrictive condition cannot be alone in a vehicle with the driver. In such case, a departure chain can violate a particular restrictive occupancy constraint when a requester that is associated with a restrictive parameter is the last passenger in the vehicle. In such case, the restrictive occupancy condition can be avoided by resequencing the particular transport chain, such that the requester with the restrictive occupancy condition is dropped-off when at least one other passenger is in the vehicle. Thus, the network system 100 can, in some cases, reconfigure the violating transport chain in a simulated group of transport chains, in order to avoid violating the restrictive occupancy constraint.

In some cases, constraints can also be handled by corrective action. For example, a restrictive occupancy constraint can be handled by including an extra passenger in the vehicle. The extra passenger can correspond to a designated personnel, or to a person with a designated role, such as chaperone or guard. When a simulated group of transport chains is determined to include one or more transport chains that violate a restrictive occupancy constraint, the network system 100 can assign additional designated personnel to the violating transport chains, so that the restrictive occupancy conditions are not violated.

The network system 100 determines group-level metrics for each simulated group of transport chains (320). As described with other examples, the group-level metrics can include a summation or average (e.g., mean, median, mode, weighted mean, etc.) of the distance or duration of travel for all of the transport chains in the simulated group. As an addition or variation, the group-level metric can include a summation or average (e.g., mean, median, mode, weighted mean, etc.) for all of the job orders that are to be fulfilled by a simulated group of transport chains. As another example, the group-level metric can include a number of vehicles that are used in the group of transport chains.

In an implementation where a simulated group of transport chains is ignored because one or more of the transport chains violate a constraint, the group -level metric is not calculated, and the particular group of transport chains is not considered for selection.

In an implementation where a simulated group of transport chains includes one or more transport chains that are re-sequenced or otherwise reconfigured to avoid, for example, the restrictive occupancy constraint, the network system 100 determines the group-level metric based with the violating transport chains being re-configured.

Sill further, there can be situations where a feasible solution cannot be determined transporting, by group transport chain, all of the requesters. For example, there may be situations where the passenger capacity of the available vehicles for the transport chain is M, and the number of requesters is N, where N is greater than M. In such case, a partial solution can be determined, where the transport chain transports a portion (e.g., M) of the requesters, and the remainder (N-M) are declined, instructed towards another transport opportunity, or provided another form of transport service (e.g., singular transport through ride-share service).

Still further, in an implementation where a simulated group of transport chains includes one or more transport chains that are to carry designated personnel to accommodate the restrictive occupancy condition, the network system 100 determines the group-level metric with the designated personnel included in the violating transport chain. For example, the group metric can include an additional value that accounts for at least one endpoint of the transport chain being for transporting the designated personnel.

The network system optimizes the group of transport chains by selecting the simulated grouping which has the most optimal value for a particular group-level metric or set of group-level metrics (330). For example, the simulated group of transport chains with the least total completion time, followed by number of vehicles used, can be selected as the optimal configuration for the group of transport chains. In additional variations, the selected group of transport chains can be based on the simulated transport chain that minimizes a cost function that is based in part on the group-level metric(s). The selected group of transport chains can also not be violative of any constraints that may be otherwise be in force.

### Hardware Diagram

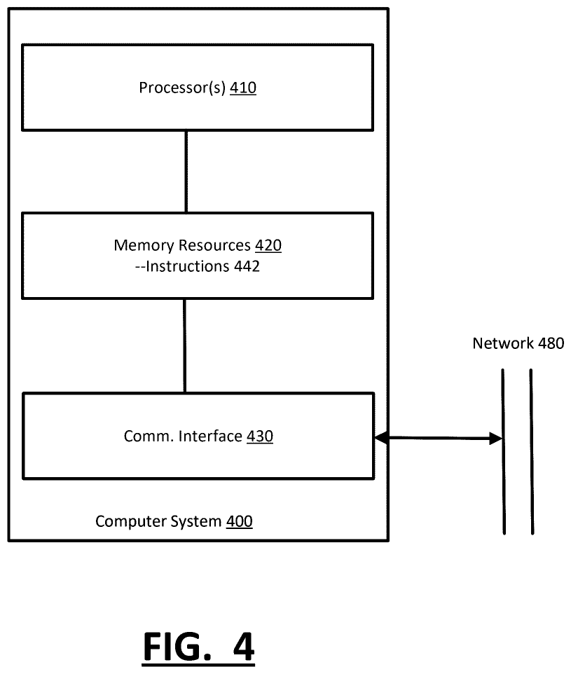

FIG. 4 is a block diagram that illustrates a computer system upon which one or more embodiments described herein may be implemented. For example, in the context of FIG. 1, the network system 100 may be implemented using a network computer system or combination of computer systems, such as described with an example of FIG. 4. Additionally, methods such as described with examples of FIG. 2 and FIG. 3 can be implemented using a computer system such as described with an example of FIG. 4.

In one implementation, the computer system 400 includes one or more processors 410, memory resources 420, and a communication interface 430. The computer system 400 includes at least one processor 410 for processing information. The memory resources 420 may include a random-access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 400 may also include other forms of memory resources, such as static storage devices for storing static information and instructions for the processor 410. The memory resources 420 can store information and instructions, including instructions 442 for implementing a network system 100, such as described with an example of FIG. 1. Additionally, the processor(s) 410 can execute the instructions 442 to implement methods such as described with example methods of FIG. 2 and FIG. 3.

The communication interface 430 can enable the computer system 400 to communicate with one or more networks 480 (e.g., cellular network) through use of the network link (wireless or wireline). Using the network link, the computer system 400 can communicate with one or more other computing devices and/or one or more other servers or data centers. In some variations, the computer system 400 can receive transport requests from requester devices via the network link 480. Additionally, the computer system 400 can receive information from provider devices, from which forecasts of provisioning levels, location bias and other aspects described herein may be determined.

Examples described herein are related to the use of the computer system 400 for implementing the techniques described herein. According to one embodiment, those techniques are performed by the computer system 400 in response to the processor 410 executing one or more sequences of one or more instructions contained in the memory resources 420. Such instructions may be read into the memory resources 420 from another machine-readable medium, such as the storage device. Execution of the sequences of instructions contained in the memory resources 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### Conclusion

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network system comprising:
one or more processors;
a memory to store instructions;
wherein the one or more processors execute the instructions to perform operations comprising:
determining a plurality of transport job orders for transporting a plurality of users either to or from a common site, wherein each transport job order is associated with a requester identifier and a corresponding geographic endpoint;
determining a group of transport chains to fulfill the plurality of transport job orders, each transport chain of the group being represented in a service data store by a corresponding transport chain record that is associated with a group identifier representing the group of transport chains;
wherein each transport chain record references multiple transport job orders of the plurality of transport job orders, the common site, and a boundary time for when the transport chain is either terminated at the common site or initiated from the common site;
for each transport chain of the group, communicating with a provider computing device of a corresponding provider, while the corresponding provider is operating a provider vehicle to service the transport chain, to determine a current location of the corresponding provider;
associating each transport chain record of the group with the current location of the provider computing device; and
transmitting, over one or more networks, data to a computing device associated with the requester identifier of each transport job order to cause that computing device to provide information about a transport chain of the group that includes the transport job, the provided information indicating the current location of the provider for the transport chain.

2. The network system of claim 1, wherein the group of transport chains are determined based on one or more group-level objectives, including an objective to minimize at least one of (i) a number of transport chains or vehicles to fulfill the plurality of transport job orders, (ii) an aggregation of a chain completion time for each transport chain of the group, or (iii) an aggregation of a chain travel distance for each transport chain of the group.

3. The network system of claim 1, wherein updating each transport chain record of the grouping includes updating an estimated time of arrival of the provider to the common site.

4. The network system of claim 1, wherein updating each transport chain record of the grouping includes updating an estimated time of arrival of the provider to the geographic endpoint of one or more transport job orders referenced by the transport chain record.

5. The network system of claim 1, wherein determining the plurality of transport job orders is performed by the one or more processors during a designated time interval that precedes the predetermined boundary time, the designated time interval following a cut-off time for receiving a plurality of transport requests, each transport job order of the plurality of transport job orders being based at least in part on a transport request of the plurality of transport requests.

6. The network system of claim 2, wherein determining the plurality of transport job orders includes accessing profile information associated with the requester identifier of each transport job order, to determine the corresponding geographic endpoint for the transport job order.

7. The network system of claim 1, wherein the operations further comprise:
accessing profile information associated with the requester identifier of each transport job order, to identify requesters that are associated with a restrictive occupancy condition; and
wherein one or more of the group of transport chains is configured to prevent or accommodate a requester that is associated with the restrictive occupancy condition.

8. The network system of claim 7, wherein the one or more transport chains is configured to accommodate the requester that is associated with the restrictive occupancy condition by assigning a designated person to be present in the provider vehicle that services the transport chain, at least during an interval during which the transport chain is being serviced while a restrictive occupancy condition is present.

9. The network system of claim 8, wherein the group of transport chains is determined to minimize a number of instances in which the restrictive occupancy condition is present.

10. The network system of 9, wherein determining the group of transport chains includes selecting one or more transport chains that are sequenced to prevent an occurrence of the restrictive occupancy condition being present.

11. The network system of claim 1, wherein determining the group of transport chains includes sequencing the corresponding geographic endpoints of each transport chain based at least in part on an objective to minimize a distance or time of travel for completing the transport chain.

12. The network system of claim 1, wherein the operations include:
determining the common boundary time based on a shift schedule provided or published by an entity of the common site.

13. The network system of claim 1, wherein transmitting data to the computing device associated with the requester identifier of each transport job includes providing the computing device with one of (i) a pickup time for picking up a requester of the computing device at a corresponding geographic endpoint, or (ii) a drop-off time for dropping off a requester of the computing device at the corresponding geographic endpoint.

14. The network system of claim 13, wherein the operations further comprise:
providing the computing device associated with each of the plurality of transport jobs with a corresponding unique code; and
associating the corresponding unique code that is provided to the computing device associated with each of the plurality of transport jobs with the transport chain that is to be used to transport a requester of the computing device.

15. The network system of claim 1, wherein the operations further comprise:
assigning the group of transport chains to a carrier entity;
receiving, from the carrier entity, a vehicle or provider identifier for each transport chain of the group; and
updating the corresponding transport chain record to reference the vehicle or provider identifier.

16. A non-transitory computer-readable medium that stores instructions, which when executed by a computer system, cause the computer system to perform operations that include:
determining a plurality of transport job orders for transporting a plurality of users either to or from a common site, wherein each transport job order is associated with a requester identifier and a corresponding geographic endpoint;
determining a group of transport chains to fulfill the plurality of transport job orders, each transport chain of the group being represented in a service data store by a corresponding transport chain record that is associated with a group identifier representing the group of transport chains,
wherein each transport chain record references multiple transport job orders of the plurality of transport job orders, the common site, and a boundary time for when the transport chain is either terminated at the common site or initiated from the common site;
for each transport chain of the group, communicating with a provider computing device of a corresponding provider, while the corresponding provider is operating a provider vehicle to service the transport chain, to determine a current location of the corresponding provider;
associating each transport chain record of the group with the current location of the provider computing device; and
transmitting, over one or more networks, data to a computing device associated with the requester identifier of each transport job order to cause that computing device to provide information about a transport chain of the group that includes the transport job, the provided information indicating the current location of the provider for the transport chain.

17. The non-transitory computer-readable medium of claim 16, wherein the group of transport chains are determined based on one or more group-level objectives, including an objective to minimize at least one of (i) a number of transport chains or vehicles to fulfill the plurality of transport job orders, (ii) an aggregation of a chain completion time for each transport chain of the group, or (iii) an aggregation of a chain travel distance for each transport chain of the group.

18. The non-transitory computer-readable medium of claim 16, wherein updating each transport chain record of the grouping includes updating an estimated time of arrival of the provider to the common site.

19. The non-transitory computer-readable medium of claim 16, wherein updating each transport chain record of the grouping includes updating an estimated time of arrival of the provider to the geographic endpoint of one or more transport job orders referenced by the transport chain record.

20. A method for arranging groups of transport chains, the method being implemented by one or more processors and comprising:
determining a plurality of transport job orders for transporting a plurality of users either to or from a common site, wherein each transport job order is associated with a requester identifier and a corresponding geographic endpoint;
determining a group of transport chains to fulfill the plurality of transport job orders, each transport chain of the group being represented in a service data store by a corresponding transport chain record that is associated with a group identifier representing the group of transport chains,
wherein each transport chain record references multiple transport job orders of the plurality of transport job orders, the common site, and a boundary time for when the transport chain is either terminated at the common site or initiated from the common site;
for each transport chain of the group, communicating with a provider computing device of a corresponding provider, while the corresponding provider is operating a provider vehicle to service the transport chain, to determine a current location of the corresponding provider;
associating each transport chain record of the group with the current location of the provider computing device; and
transmitting, over one or more networks, data to a computing device associated with the requester identifier of each transport job order to cause that computing device to provide information about a transport chain of the group that includes the transport job, the provided information indicating the current location of the provider for the transport chain.
